(19) United States
(12) Patent Application Publication
(10) Pub. No.: US 2023/0263203 A1
(43) Pub. Date: Aug. 24, 2023

(54) COMPOSITION

(71) Applicant: Givaudan SA, VERNIER (CH)

(72) Inventors: Simona BIRTIC, Cavaillon (FR); Michael LAGUERRE, Le Pontet (FR); François-Xavier Henri PIERRE, Saint Saturnin les Avignon (FR); Mathieu TENON, Malemort du Comtat (FR); Jérôme GARCIA-MUNOZ, Vedène (FR)

(21) Appl. No.: 18/004,090

(22) PCT Filed: Jul. 5, 2021
(86) PCT No.: PCT/EP2021/068462

§ 371 Date: Jan. 3, 2023

(30) Foreign Application Priority Data
Jul. 7, 2020 (GB) 2010424.6

(51) Int. Cl. A23L 27/00; A23L 33/105; A23F 5/02

(52) U.S. Cl. CPC A23L 27/84; A23L 33/105; A23F 5/02

(57) ABSTRACT

The present invention relates to improved compositions comprising CGA(s).

### FIELD OF THE INVENTION

The present invention relates to stable compositions comprising chlorogenic acids.

### BACKGROUND OF THE INVENTION

Antioxidants (AOX) are substances that help protect cells from the damages caused by unstable molecules, such as free radicals and active oxygen species. Such damage may lead to cancer, and thus protecting cells via antioxidants has become a leading interest in the fight against cancer as studies now indicate that antioxidants may slow or possibly prevent the development of cancer.

Oxidation or oxidative stress may be a primary cause of many chronic diseases, including cancer, as well as the aging process itself. As a result, much research exists and is ongoing related to the role that antioxidants play in hindering oxidation, thereby delaying or preventing oxidative stress. Both endogenous and exogenous antioxidants may play a role in controlling oxidation and preventing disease.

In practice, antioxidants interact with and stabilize free radicals and may prevent some of the damage free radicals otherwise might cause. Antioxidants neutralize free radicals as the natural by-product of normal cell processes. Antioxidants are often described as “mopping up” free radicals, meaning they neutralize the electrical charge and prevent the free radical from taking electrons from other molecules. Antioxidants also often neutralize non-charged free radicals.

Apart from health benefits, antioxidants preserve food and beverages from oxidation and thus increase their shelflife.

One type of antioxidant is the group of compounds called polyphenols. Polyphenols are common constituents of foods of plant origin and contribute the major antioxidants found in diets. The main dietary sources of polyphenols are fruits, vegetables, and beverages. For example, a typical cup of coffee may contain 70-350 mg chlorogenic acids (CGAs), the predominant polyphenolic compound in coffee.

Several thousand different polyphenols have been identified in foods. The two main types of polyphenols are flavonoids and phenolic acids. Some of the more common flavanoids are quercetin (found in onion, tea, apple), catechin (tea, fruit), hesperidin (citrus fruits), and cyanidin (red fruits). One of the most common phenolic acids is caffeic acid, present in many fruits and vegetables. Caffeic acid, most often esterified with quinic acid as in chlorogenic acid, is the major phenolic compound in coffee.

As antioxidants, these polyphenols may protect cell constituents against oxidative damage and therefore reduce the risk of various degenerative diseases, such as cancer, cardiovascular disease, neurodegenerative diseases, diabetes, etc. These degenerative diseases are associated with oxidative damage to cell components, DNA, proteins, and lipids. Antioxidants present in foods and beverages can help limit this damage by acting directly on reactive oxygen species or by stimulating endogenous cell defense systems. The phenolic group in polyphenols can donate hydrogen to a radical, thereby disrupting chain oxidation reactions in cellular components. Epidemiological studies have clearly shown that diets rich in plant foods protect is humans against degenerative diseases, such as cancer and cardiovascular disease. As mentioned, plant foods contain a variety of polyphenolic compounds, which are increasingly shown to be effective protective agents (See: Manach et al., 2005, Am. J. Clin. Nutri. 81: 230S-42S).

Increasingly, scientific research is discovering that coffee has a surprisingly high number of beneficial health effects, including as a source of antioxidants. The results of epidemiological studies suggest that coffee consumption is associated with decreased risk of type 2 diabetes, Parkinson's disease, and liver disease. For example, men who drank at least six (6) cups of coffee daily had a risk of developing type 2 diabetes that was 54% lower than men who did not drink coffee, and women who drank at least six (6) cups of coffee daily had a risk of type 2 diabetes that was 29% lower than women who did not drink coffee (See: Salazar-Martinez et al., 2004, Ann Intern Med. 140:1-8). In a prospective study of 47,000 men, those who regularly consumed at least one (1) cup of coffee daily had a 40% lower risk of developing Parkinson's disease over the next 10 years than men who did not drink coffee (See: Ascherio et al., 2001, Ann Neurol. 50: 56-63). Evidence also suggests that drinking coffee reduces the risk of colon cancer, cirrhosis, and liver cancer.

As mentioned above and as is well known in the scientific and medical arts, coffee contains a high level of chlorogenic acids, about 5% on a dry weight basis. As also mentioned, chlorogenic acids are polyphenolic antioxidants, similar to the healthy polyphenols that are present in other natural products such as tea, berries, and vegetables. Thus, these chlorogenic acid coffee antioxidants, as well as others, provide health benefits through direct action against free radicals, as mentioned above, as well as indirect actions by modifying metabolism including activation of cellular defenses. Given the increasing emphasis on health and well-being in society, these benefits are important and have become increasingly recognized. Coffee antioxidants are also effective as preservatives for food and beverages, decreasing flavor deterioration and fat oxidation, like more traditional antioxidants, such as butylated hydroxyanisole (BHA), a synthetic antioxidant, or Vitamin E. Other known benefits include use of chlorogenic acids and polyphenols as flavor pre-cursors.

Moreover, growing knowledge about the health promoting effects of antioxidants in everyday foods, combined with the negative consumer image of synthetic antioxidants (such as BHA, butylated hydroxytoluene (BHT), and tertiary butyl hydroquinone (TBHQ), and possible safety issues with synthetic antioxidants, have led to an explosion in the desire to use natural antioxidants. However, many natural antioxidants are expensive and thus cost prohibitive because they are extracted from higher value agricultural commodities such as fruits, spices, and even coffee. A potentially much less expensive source of natural antioxidants would be a process stream, such as a waste stream, from current food and beverage processes, such as a coffee bean decaffeination process.

Because of the health benefits associated with antioxidants as described above, and the increasing awareness of the health benefits of coffee, which includes antioxidants, additional uses of coffee, or its extracts rich in chlorogenic acid, are to prevent food or beverages from oxidation.

Indeed, in food and beverage industry, such extracts are used to prevent flavours and colours from oxidation. For beverages, coffee extracts are desirable to be used in liquid form and to this end, liquid formulas should be provided. Such formulas are desired to be liquid, homogenous and free from sediments.

However, chlorogenic extracts formulations developed fairly quickly, within days an unwanted sediment.

There remains therefore a need for new compositions and formulations that result in stable solutions and do not develop unwanted sediments.

### SUMMARY OF THE INVENTION

Accordingly, in a first aspect, the invention provides a composition (or composition of the invention) comprising
i) at least one chlorogenic acid
ii) a carrier comprising at least one carrier other than water and/or water.

In one embodiment, the at least chlorogenic acid is a natural extract, thus in another aspect, the invention provides a composition comprising
(i) a natural extract comprising at least one chlorogenic acid and
(ii) a carrier comprising at least one carrier other than water and/or water, wherein the natural extract is extracted using water, alcohol, acetone, ethyl acetate, hexane, dichloromethane and any mixtures thereof.

In another aspect, the invention provides the use of a composition of the invention in a nutraceutical formulation, a dietary, food or drink product for humans or animals, a nutritional supplement, a sports supplement, a fragrance or flavoring, a pharmaceutical or veterinary formulation, an oenological or cosmetic formulation.

In another aspect, the invention provides a nutraceutical formulation, a dietary, food or drink product for humans or animals, a nutritional supplement, a sports supplement, a fragrance or flavoring, a pharmaceutical or veterinary formulation, an oenological or cosmetic formulation comprising a composition of the invention.

In another aspect the invention provides the use of a composition of the invention to prevent flavours and/or colours oxidation in a beverage or food product.

The details, examples and preferences provided in relation to any one or more of the stated aspects of the present invention will be further described herein and apply equally to all aspects of the present invention. Any combination of the embodiments, examples and preferences described herein below in all possible variations thereof is encompassed by the present invention unless otherwise indicated herein, or otherwise clearly contradicted by context.

### DETAILED DESCRIPTION OF THE INVENTION

It is to be understood that both the foregoing general description and the following detailed description are exemplary and explanatory only and are not restrictive of the embodiments, as claimed. Herein, the use of the singular includes the plural unless specifically stated otherwise. As used herein, the use of “or” means “and/or” unless stated otherwise. Furthermore, the use of the term “including” as well as other forms, such as “includes” and “included”, is not limiting.

The section headings used herein are for organizational purposes only and are not to be construed as limiting the subject matter described. All documents, or portions of documents, cited in this application, including, but not limited to, patents, patent applications, articles, is books, etc are hereby expressly incorporated by reference for the portions of the document discussed herein, as well as in their entirety.

According to the present invention, there is provided a composition, or composition of the invention, comprising (i) at least one chlorogenic acid and (ii) a carrier comprising at least one carrier other than water and/or water.

In one embodiment, the at least chlorogenic acid is a natural extract, thus in another aspect, the invention provides a composition comprising
(i) a natural extract comprising at least one chlorogenic acid and
(ii) a carrier comprising at least one carrier other than water and/or water, wherein the natural extract is extracted using water, alcohol, acetone, ethyl acetate, hexane, dichloromethane and any mixtures thereof.

Chlorogenic acid(s) are widely distributed in the plant kingdom and occurs in fruits, leaves and other tissues of dicotyledonous plants.

Hereinafter the term “CGA(s)” or “chlorogenic acid(s)” or will mean one or more chlorogenic acid(s) and their derivatives naturally occurring in plants, including but not limited to neo-chlorogenic acid (neo-CGA; 5-O-caffeoylquinic acid or 5-CQA), crypto-chlorogenic acid (crypto-CGA; 4-0-caffeoylquinic acid or 4-CQA), n-chlorogenic acid (n-CGA; 3-O-caffeoyl quinic acid or 3-CQA), iso-chlorogenic acid A (iso-CGA A; 3,5-dicaffeoylquinic acid) iso-chlorogenic acid B (iso-CGA B; 3,4-dicaffeoylquinic acid), iso-chlorogenic acid C (iso-CGA C; 4,5-dicaffeoylquinic acid), other chlorogenic acids and iso-chlorogenic acids known to art, and combinations thereof.

The % of CGA(s) in the composition of the invention can be from about 0.5 to about 99%, as from about 0.5, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39 or 40% to about 99, 90, 80, 70, 60, 50% w/v. In a preferred embodiment the % of CGA(s) is from 3 to 10%, more precisely from 4.5 to 5% w/w.

The CGA(s) may be of natural origin or may be or synthetic origin.

CGA(s) may be extracted from a variety of natural sources. Thus in a preferred embodiment, the chlorogenic acid(s) is extracted from a biological material that contains chlorogenic acid(s).

“Biological material” refers to any material that has been obtained from or is obtainable from plants (plant biological material), animals (animal biological material) or prokaryote (prokaryotic biological material).

As used herein, the term “plant biological material” is material that has been obtained from or is obtainable from plants (including algae), such as roots and/or the aerial parts of the plant, such as leaves, flowers, stems, barks, fruits or seeds or their tissues. For example, the plant biological material may be obtained from the fruits of the plant. Plant biological material includes also residues from agricultural harvesting and industrial processing of said materials.

As used herein, the term “animal biological material” is material that has been obtained from or is obtainable from an animal source, such as from secretions from the glands of mammals.

As used herein, the term “prokaryotic biological material” is material that has been obtained from or is obtainable from single cell organisms, such as bacteria.

“Chlorogenic acid(s) containing biological material” means that the biological extract comprises about 0.05% or more by weight of one or more chlorogenic acid(s).

For example, the CGA(s) containing biological material may comprise about 0.5% or more, 2% or more, about 5% or more, about 10% or more, about 20% or more, or about 40% or more by weight of CGA(s).

The CGA(s) containing biological material is preferably plant biological material. The plant biological material may be obtained from or obtainable from plant roots and/or plant aerial parts, such as the leaves, flowers, stems, barks, fruits and/or seeds, their tissues (such as the rind of the fruit) or mixtures thereof. For example, the plant biological material may be the leaves of the plant.

As will be appreciated by the person skilled in the art, as used herein the term “obtainable from” means that the plant and/or animal and/or prokaryotic biological material may be obtained from a plant/algae/animal/prokaryote directly or may be isolated from the plant/algae/animal/prokaryote, or may be obtained from an alternative source, for example by chemical synthesis or enzymatic production. Whereas the term “obtained” as used herein, means that the extract is directly derived from the plant/algae/animal/prokaryote source.

For example, the composition of the invention comprises
i) at least one chlorogenic acid such as a natural extract comprising at least one clorogenic acid and
ii) a carrier comprising at least one carrier other than water and/or water wherein the at least one chlorogenic acid is extracted form a biological material (such as a plant biological material).

Non-limitative examples of CGA(s) containing plant biological material are green coffee beans from any species of the genus Coffea such as Coffea arabica (Arabica), Coffea conephora (Robusta), Coffea liberica (Liberica), etc; leaves of Ilex paraguariensis, pome fruits (e.g., apples and pears), stone fruits (e.g., cherries and plums), berry fruits, citrus fruits, brassica vegetables (e.g., kale, cabbage and brussel sprouts), solanaceae (e.g., potato tubers, tomatoes, and aubergines), asteraceae (e.g., chicoryroot and artichokes), and a variety of other miscellaneous vegetables. It may also be found in cereal grains (e.g., oats, barley, rye, rice, corn and wheat). The amount and different types of chlorogenic acid that are present vary depending upon the source. Chlorogenic acid may be extracted from one or more botanical sources, and/or synthetic chlorogenic acid may be used.

In a preferred embodiment, the CGA(s) containing plant biological material is Arabica, Robusta and/or Liberica green coffee beans.

The CGA(s) of natural origin can be present in the composition of the invention as purified CGA(s) or as natural extracts obtained or obtainable from any of the CGA(s) containing biological material (such as Arabica, Robusta and/or Liberica green coffee beans) mentioned before.

The CGA(s) containing biological material (such as Arabica, Robusta and/or Liberica green is coffee beans) may be ground into granules with a particle size in a range from about 0.1 mm to about 30 mm, to increase the surface area for the solvent to contact and to increase extraction efficiency.

For example, the composition of the invention comprises
i) a natural extract comprising clorogenic acids and
ii) a carrier comprising at least one carrier other than water and/or water,
   wherein the natural extract comprising clorogenic acids is extracted form a plant biological material (such as green Arabica, Robusta and/or Liberica green coffee beans) and wherein the natural extract is extracted using water, alcohol, acetone, ethyl acetate, hexane, dichloromethane and any mixtures thereof.

Particular solvents that may be used in the extraction process include water, alcohols (such as methanol, ethanol), acetone, ethyl acetate, hexane, dichloromethane, and any mixtures thereof, such as alcohol/water mixtures (such as mixtures of methanol and water). In a preferred embodiment the solvent is any alcohol or solvent that is miscible with water.

For example, the extraction solvents can be water, a water-alcohol mixture (from about 1% to about 99% alcohol in water. For example, from about 30% to about 75% alcohol in water, or from about 30% to about 50% alcohol in water, such as from about 35% or from about 40% alcohol in water), or alcohol. Particular alcohols that may be mentioned include ethanol (EtOH) and methanol (MeOH).

In particular embodiments, the extraction solvent may be a methanol-water mix, such as from about 30% to about 90% methanol in water, or from about 30% to about 50% methanol in water. For example, from about 50% or from about 80% ethanol in water. In a preferred embodiment the extraction solvent is ethanol-water mix with about 75% methanol and about 25% water.

In one embodiment, the temperature of extraction is in a range of from about 20° C. to about 100° C. In a particular embodiment, the temperature for extraction is in a range of from about 50° C. to about 70° C. Typically, the ratio of plant material to solvent mixture used in the extraction process varies from about 1:1 to about 1:10 on a gram to milliliter basis, such is as from about 1:3 to about 1:8. The incubation period (i.e. the period during which the plant material is in contact with the solvent) is typically from about 2 hours to about 24 hours.

Mechanical energy can be applied during the extraction process. Applying mechanical energy helps to homogenizes the mixture, changes the physical structure of the starting CGA(s) containing biological material (such as green Robusta and/or Arabica coffee beans) and increases the extraction yields of CGA(s). The amount of mechanical energy applied in the method depends on at which step applied, the type of starting CGA(s)-containing biological material, the amount of the starting CGA(s)-containing biological material used in the mixture, the pH of the mixture, and the temperature of the mixture. The amount of mechanical energy also can influence the amount of time needed to complete the extraction of the CGA(s) from the CGA(s)-containing biological material.

For example, the biological material (such as Arabica, Robusta and/or Liberica green coffee beans) and the extraction solution (such as methanol-water mix) may be mixed using techniques known in the art, for example using stirring, maceration, percolation or infusion, such as magnetic or mechanical stirring.

Stirring may be conducted at any suitable revolution per minute (rpm), for example, the stirring may be done from about 1 rpm or about 10 rpm or about 50 rpm to about 500 rpm. For mechanical stirring this may typically be done from about 1 rpm to 500 rpm, such as from about 10 rpm to about 200 rpm.

Devices for applying mechanical energy can be a pump, a refiner, a homogenizer, an extruder, a lobe pump, and/or a centrifugal pump. The mixture can be circulated in a closed-loop system that includes a pressure vessel (able to contain a heated solvent mixture), a reflux vessel, a heat exchanger, such as a shell and tube heat exchanger, and a pump for recirculating the heated mixture back to the vessel, allowing multiple passes through the pump in the system.

After the CGA(s) containing biological material (such as Arabica, Robusta and/or Liberica green coffee beans) and solvent have been incubated, the solvent is separated from residual biological material by any suitable separation technique known in the art (like for example filtration).

Optionally, the solvent (containing the CGAs) separated from residual biological material can be supplemented with organic or weak or strong acid such as citric acid, tartaric acid, malic acid, folic acid, fumaric acid, lactic acid, hydrochlorhydric acid and/or sulphuric acid at a concentration from 0.1% w/w to about 10% w/w. In a preferred embodiment the acid is citric acid and it is added at 0.1 w/w to 10% w/w, with a preference of about 2% w/w.

Further filtration steps can be used. The solvent may be partially or totally removed by any method know in the art.

Sterilisation methods can be applied at any step of extraction.

The term “Natural extracts comprising CGA(s)” in the present invention refers to an extract obtained using methods as previously defined that comprises CGA(s) and other natural components such as terpenes, phenolic compounds, amino acids, flavonoids, volatile oils, vitamins, minerals and mixtures thereof, and wherein the extract comprising CGA(s) is not further purified for example using resin columns, activated carbon, clays and other methods for removing natural occurring components and/or further concentrate the CGAs. Typically, the “Natural extracts comprising CGA(s)” extracted from a biological material may have a total Chlorogenic Acids (TCGA content) of from 3 to 50% w/w, such as from 5% to 35%, such as from 10% to 30%, such as 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 45% or 50% w/w.

The natural extracts obtained using the method described before or “natural extract comprising CGA(s) of the invention” can be presented as a concentrated liquid or as a dry form (such as a powder).

The natural extract comprising CGA(s) can be used directly to formulate the composition of the invention. The natural extract comprising CGA(s) can be in a liquid form (such as a concentrate) or it can be presented as a powder form (where all the solvent was removed).

In one embodiment the biological material is Arabica, Robusta and/or Liberica green coffee beans and the natural extracts comprising CGA(s) of the invention (such a concentrate or a dry form) comprises from about 5% to about 99%, from about 5% to about 40%, from about 10% to about 35% w/w, more precisely about 33% w/w of solids and/or a TCGA content from 3% to 50%, such as from about 5% w/w to about 20% w/w.

In a preferred embodiment, the natural extract comprising CGA(s) is a concentrated liquid extract wherein the solvent has being decreased and the concentrate extract comprises dry matter from about 13% to 50%, such as from about 20% to about 40%, such as from 30% to 35% such as 33% w/w. In a preferred embodiment, biological material is Arabica, Robusta and/or Liberica green coffee beans and the TCGA content is from 3% to 50%, such as from 10% to about 20% w/w, such as from about 13% to about 16% w/w TCGA.

In another preferred embodiment the solvent may be completely removed and the dry extract comprises CGA(s) from 3% to 50% w/w, such as from 5% to 35% w/w, such as from 10% to 30% w/w, such as 3% w/w, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40% 50% w/w.

For example, the composition of the invention comprises
(i) a natural extract comprising at least one chlorogenic acid
(ii) a carrier comprising at least one carrier other than water and/or water
wherein the natural extract comprising CGA(s) is extracted from a biological material (such as Arabica, Robusta and/or Liberica green coffee beans) using a methanol/water solvent.

Herein the term “TCGA content” will mean Total Chlorogenic Acids (TCGA) content, and it will be calculated as the sum of the concentrations of one of more of the CGA(s) mentioned before in a w/w dry basis.

This natural extract can be used for the formulation of the composition of the invention.

However, after completion of the extraction process, the CGA(s) can themselves be isolated from the extract (i.e. purified) using suitable purification processes such as a chromatographic process and/or other process that involve active carbon, acid clays or activated clays, etc; thus being “purified CGA(s)”.

For example, purified CGA(s) may be obtained using the following process:
the natural source containing CGA(s) such as Arabica, Robusta and/or Liberica green coffee beans powder (i.e. obtained by preparing ground Arabica, Robusta and/or Liberica green coffee beans) is dissolved in an alcohol and the CGA(s) are extracted by alcohol (such as methanol) from the powder.

The alcohol is then evaporated and the remaining residue including CGA(s) is loaded into a chromatography column filled with reverse-phase C-18 resin;
several fractions containing different compounds are eluted with a series of water and 10% MeOH/90% water, and MeOH system. The fractions are compared by high performance liquid chromatography (HPLC) analysis and those elutes having similar HPLC patterns are combined;
the combined fractions are separated on normal phase silica gel column chromatography and eluted with chloroform (CHCl3), CHC
methanol mixture starting from 90%, 80% CHCl3 to 100% w/w MeOH to give several subfractions. The sub-fractions are compared by HPLC and the fractions which contain CGA(s) are combined, respectively. The combined fractions are further purified by a combination of column chromatography over C-18, MCI GEL CHP-20P and/or Sephadex LH-20 resins to provide pure CGA(s).

The terms “isolated” and “purified” as used herein refer to the extract or CGA(s) being separated from at least one other component (e.g. terpenes, phenolic compounds, amino acids, flavonoids, volatile oils, vitamins, minerals etc) present with the extract or CGA(s) in its natural source. In one embodiment, the extract or CGA(s) are provided in pure form or in the presence of a solvent, buffer, ion, or other component normally present in a solution of the same. In one embodiment, the purified CGA(s) is more that 60% w/w, 70% w/w, 80% w/w, such as more than 99% w/w.

In a preferred embodiment, the natural extract is not further purified.

The natural extract can be used for the formulation of the composition of the invention. The natural extract comprising CGA(s) is formulated with a carrier comprising at least one carrier other than water and/or water.

In a preferred embodiment the composition of the invention has a TCGA content of 3% w/w, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39% or 40% w/w to about 99%, 90%, 80%, 70%, 60%, 50% w/w. In a preferred embodiment the TCGA content is of from about 3% to 10%, more precisely from 4.5% to 5% w/w (in relation with the total weight of the composition of the invention).

For example, the composition of the invention comprises
i) a natural extract comprising chlorogenic acids and
ii) a carrier comprising at least one carrier other than water and/or water
   wherein the natural extract is a methanol/water natural extract comprising CGA(s) extracted from a biological material (such as Arabica, Robusta and/or Liberica green coffee beans), and wherein the total Chlorogenic Acids content of the composition is from about 3% to about 10%, more precisely from about 4.5% to about 5% w/w.

In a preferred embodiment the CGA(s) are of natural origin obtained or obtainable from a CGA(s) containing biological material (such as Arabica, Robusta and/or liberica green coffee beans) and comprises neo-chlorogenic acid (neo-CGA; 5-O-caffeoylquinic acid or 5-CQA), crypto-chlorogenic acid (crypto-CGA; 4-0-caffeoylquinic acid or 4-CQA), n-chlorogenic acid (nCGA; 3-O-caffeoyl quinic acid or 3-CQA), iso-chlorogenic acid A (iso-CGA A; 3,5-dicaffeoylquinic acid) iso-chlorogenic acid B (iso-CGA B; 3,4-dicaffeoylquinic acid), iso-chlorogenic acid C (iso-CGA C; 4,5-dicaffeoylquinic acid) or any combination of any of said CGA(s) or other CGA(s) described on the literature.

For example, the composition of the invention comprises
i) a natural extract comprising chlorogenic acids (such as neo-chlorogenic acid (neo-CGA; 5-O-caffeoylquinic acid or 5-CQA), crypto-chlorogenic acid (crypto-CGA; 4-0-caffeoylquinic acid or 4-CQA), n-chlorogenic acid (n-CGA; 3-O-caffeoyl quinic acid or 3-CQA), iso-chlorogenic acid A (iso-CGA A; 3,5-dicaffeoylquinic acid) iso-chlorogenic acid B (iso-CGA B; 3,4-dicaffeoylquinic acid), iso-chlorogenic acid C (iso-CGA C; 4,5-dicaffeoylquinic acid) and mixtures thereof), and
ii) a carrier comprising at least one carrier other than water and/or water.

In a preferred embodiment, the composition of the invention has from about 3 to about 10%, more precisely from about 4.5% to about 5% w/w of CGA(s). In a more preferred embodiment, the at least one CGA(s) is obtained from a biological material such as Arabica, Robusta and/or Liberica green coffee beans.

The composition of the invention can be supplemented with organic or weak or strong acid such as citric acid, tartaric acid, malic acid, folic acid, fumaric acid, lactic acid, hydrochlorhydric acid and/or sulphuric acid at a concentration from 0.0001% to about 5%.

In a preferred embodiment the composition of the invention comprises acid is citric acid and at a concentration from about 0.001% to 5% w/w.

The skilled person will understand that the CGA(s) present on the composition of the invention (such a natural extract) may be provided in solid form or in liquid form. By solid form, it is included that the purified CGA(s) or the Natural extract comprising CGA(s) may be provided as an amorphous solid, or as a crystalline or part-crystalline solid.

As already mentioned, the natural chlorogenic extracts formulations developed fairly quickly, within days unwanted sediment. The inventors of the present invention have discovered that natural extracts comprising CGA(s) extracted from a biological material (such as Arabica, Robusta and/or Liberica green coffee beans) with methanol/water or ethanol/water solvents when formulated with only water or with only monopropylene glycol result in stable solutions that do not develop unwanted sediments. The composition of the invention has no precipitation that appears during time. This is advantageous because it allows the use of natural extract in various applications without further purification and/or refinement (such as column purifications, active carbon purifications etc).

The composition of the invention further comprises a carrier comprising at least one carrier other than water and/or water.

As used herein, the term “carrier” is material that can be used to dilute or to dissolve the is other components (such as the CGA(s) or the “Natural extract comprising CGA(s)”) used in the art for liquid ingredients with a use for food or beverages. In the present invention the carrier may comprise only water. In another embodiment, the carrier may comprises only at least one carrier other than water, that is the carrier comprises one or more carriers other than water but it is essentially free of water.

Without limitation, and only by way of illustration, suitable “carriers (diluent or solvent) other than water”, which may be used in the composition of the invention are known to those skilled in the art and include e.g. ethanol, methanol, monopropylene glycol, ethylene glycol, glycerine and triacetin; and mixtures thereof.

Examples of carriers, diluents or solvents for flavor compounds may be found e.g, in “Perfume and Flavour Materials of Natural Origin”, S. Arctander, Ed., Elizabeth, N.J., 1960; in “Perfume and Flavour Chemicals”, S. Arctander, Ed., Vol. I & II, Allured Publishing Corporation, Carol Stream, USA, 1994; in “Flavourings”, E. Ziegler and H. Ziegler (ed.), Wiley-VCH Weinheim, 1998, and “CTFA Cosmetic Ingredient Handbook”, J. M. Nikitakis (ed.), 1st ed., The Cosmetic, Toiletry and Fragrance Association, Inc., Washington, 1988.

In one embodiment, the at least one carrier other than water may be a carrier comprising glycol such as dipropylene glycol, n-propylene glycol, monopropylene glycol (MPG) or mixtures thereof. In a preferred embodiment the carrier other than water is monopropylene glycol (MPG).

Monopropylene glycol (also known as propylene glycol, PG, propan1, 2diol and MPG) is a clear, colourless and viscous liquid with a characteristic odour and has the formula C3H802.

The inventors have surprisingly found that if the composition of the invention is formulated only with water as carrier or only with at least one carrier (other than water) such as monopropylene glycol) no precipitation is formed.

For example, the composition of the invention comprises
i) a natural extract comprising at least one chlorogenic acid and
ii) at least one carrier (other than water) such as ethanol, methanol, monopropylene glycol (MPG), dipropylene glycol, n-propylene glycol, ethylene glycol, glycerine and/or triacetin.

In a preferred embodiment, the composition of the invention has from about 3 to about 10%, more precisely from about 4.5 to about 5% w/w of CGA(s).

For example, the composition of the invention comprises
i) a natural extract comprising at least one chlorogenic acid and
ii) at least one carrier (other than water) such as MPG,
   wherein the CGA(s) concentration is from about 3% to about 10%, more precisely from about 4.5 to about 5% w/w.

In a preferred embodiment, the at least one chlorogenic acid is a natural extract comprising CGA(s) extracted from a biological material (such as Arabica, Robusta and/or Liberica green coffee beans) using a methanol/water solvent.

In another embodiment the composition comprises only one or more carriers (other than water such as MPG) and no water (ration of water to carrier other than water of 0:1 thus is essentially free of water.

For example, the composition of the invention comprises
i) a natural extract comprising at least one chlorogenic acid and
ii) MPG.

For example, the composition of the invention comprises
i) a natural extract comprising at least one chlorogenic acid (such as Arabica, Robusta and/or Liberica green coffee beans natural extract) and
ii) MPG,
   wherein the CGA(s) concentration is from about 3% to about 10%, more precisely from about 4.5% w/w to about 5% w/w of the final composition.

For example, the composition of the invention comprises
i) a natural extract comprising at least one chlorogenic acid (such as Arabica, Robusta and/or Liberica green coffee beans natural extract comprising CGA(s)) and
ii) MPG,
   wherein the CGA(s) concentration in the natural extract is from 3% to 50%, such as from 5% to 35%, such as from 10% to 30% w/w of the natural extract.

In one embodiment, the composition of the invention comprises
i) a natural extract comprising at least one chlorogenic acid (such as Arabica, Robusta and/or Liberica green coffee beans natural extract) and
ii) MPG,
   wherein the CGA(s) concentration in the natural extract is from 3% to 50%, such as from 5% to 35%, such as from 10% to 30% w/w of the natural extract and the CGA(S) concentration in the composition is from about 3% to about 10%, more precisely from about 4.5 to about 5% w/w of the final composition.

In a preferred embodiment, the at least one chlorogenic acid is a natural extract comprising CGA(s) extracted from a biological material (such as Arabica, Robusta and/or Liberica green coffee beans) using a methanol/water solvent.

For example, the composition of the invention comprises
i) at least one chlorogenic acid and
ii) MPG.

For example, the composition of the invention comprises
i) at least one chlorogenic acid (such as purified CGA(S)) and
ii) MPG or water
   wherein the CGA(s) concentration is from about 3% to about 10%, more precisely from about 4.5% to about 5% w/w of the final composition.

For example, the composition of the invention comprises
i) at least one chlorogenic acid (such as purified CGA(S)) and
ii) MPG or water
   wherein the CGA(s) is a purified CGA(S) and having more than more that 60%, 70%, 80% or more than 99% w/w.

In one embodiment, the composition of the invention comprises
i) at least one chlorogenic acid (such as purified CGA(S)) and
ii) MPG or water
   wherein the CGA(s) is a purified CGA(S) and having more than more that 60%, 70%, 80% or more than 99% w/w, and the the CGA(S) concentration in the composition of the invention is from about 3% to about 10%, more precisely from about 4.5 to about 5% w/w of the final composition.

In one preferred embodiment, the composition comprises only water without another carrier (such as ratio of water to carrier other than water of 1:0).

In another preferred embodiment, the composition comprises water as a carrier and is essentially free of other carriers (other than water) such as less than about 0.5%, less than 0.1%, less than about 0.001% (v/v) of another carrier (such as MPG).

As “essentially free” (for example essentially free of water) it is understood in the present invention that the carrier has less than about 0.5%, less than 0.1%, less than about 0.001%, less than about 0.00001% (v/v) of a specific component (for example water).

For example, the composition of the invention comprises
i) a natural extract comprising at least one chlorogenic acid and
ii) water.

For example, the composition of the invention comprises
i) a natural extract comprising at least one chlorogenic acid (such as Arabica, Robusta and/or Liberica green coffee beans natural extract) and
ii) water,
   wherein the CGA(s) concentration is from about 3% to about 10%, more precisely from about 4.5% to about 5% w/w of the final composition.

For example, the composition of the invention comprises
i) a natural extract comprising at least one chlorogenic acid (such as Arabica, Robusta and/or Liberica green coffee beans natural extract comprising CGA(s)) and
ii) water,
   wherein the TCGA(s) concentration in the natural extract is from 3% to 50%, such as from 5% to 35%, such as from 10% to 30% w/w of the natural extract.

In one embodiment, the composition of the invention comprises
i) a natural extract comprising at least one chlorogenic acid (such as Arabica, Robusta and/or Liberica green coffee beans natural extract) and
ii) water,
   wherein the CGA(s) concentration in the natural extract is from 3% to 50% w/w, such as from 5% to 35%, such as from 10% to 30% w/w, such as from 13% to 16%, and the final CGA(S) concentration in the composition is from about 3% to about 10%, more precisely from about 4.5 to about 5% w/w of the final composition.

In a preferred embodiment, the at least one chlorogenic acid is a natural extract comprising CGA(s) extracted from a biological material (such as Arabica, Robusta and/or Liberica green coffee beans) using a methanol/water solvent.

Also, surprisingly, the inventors have shown that if the at least one chlorogenic acid is formulated with at least one carrier (other than water) and low % of water no precipitation is formed (see experiment 1).

Thus in another embodiment, the composition of the invention comprises
i) a natural extract comprising at least one chlorogenic acid (such as Arabica, Robusta and/or Liberica green coffee beans natural extract) and
ii) a carrier comprising at least one carrier other than water and/or water.

In a preferred embodiment, the composition of the invention comprises from about 3% to about 10%, more precisely from about 4.5% to about 5% w/w of CGA(s).

The ratio of the carrier other than water (such as MPG) and the water may be of more than about 1.9/1, such as about 2/1, 2.5/1, 3/1, 3.5/1, 4/1, 5/1, 6/1, 7/1, 8/1, 9/1, 10/1, 12/1, 14/1, 20/1, 30/1, 40/1, 50/1, 60/1, 70/1, 80/1, 90/1, 100/1, 1000/1 or more.

In another embodiment, the composition of the invention comprises
i) at least one chlorogenic acid (such as CGA(s) extracted from a biological material, such as Arabica, Robusta and/or Liberica green coffee beans)
ii) a carrier comprising at least one carrier other than water and/or water
   wherein the ration between the carrier other than water (such as MPG) and water may be of about more than about 1.9/1, such as about 2/1, 2.5/1, 3/1, 3.5/1, 4/1, 5/1, 6/1, 7/1, 8/1, 9/1, 10/1, 12/1, 14/1, 20/1, 30/1, 40/1, 50/1, 60/1, 70/1, 80/1, 90/1, 100/1, 500/1, 1000/1 or more.

Thus in another embodiment, the composition of the invention comprises
i) a natural extract comprising at least one chlorogenic acid (such as Arabica, Ro-busta and/or Liberica green coffee beans natural extract) and
ii) a carrier comprising at least one carrier other than water and/or water
   wherein the ration between the carrier other than water (such as MPG) and water may be of about more than about 1.9/1, such as about 2/1, 2.5/1, 3/1, 3.5/1, 4/1, 5/1, 6/1, 7/1, 8/1, 9/1, 10/1, 12/1, 14/1, 20/1, 30/1, 40/1, 50/1, 60/1, 70/1, 80/1, 90/1, 100/1, 500/1, 1000/1 or more.

In a preferred embodiment, the composition of the invention comprises from about 3% to about 10%, more precisely from about 4.5% to about 5% w/w of CGA(s).

The inventors have also surprisingly found that when the CGA(s) are formulated with water and small amounts of one or more carriers (other than water) there is also no precipitation.

Thus in another embodiment of the composition of the invention, the carrier comprises at least one carrier other than water and water, wherein the ratio between water and the at least one carrier(s) other than water (such as MPG) may be of more than about 4/1, such as about 5/1, 6/1, 7/1, 8/1, 9/1, 10/1, 12/1, 14/1, 15/1, 16/1, 17/1, 18/1, 19/1, 20/1, 30/1, 40/1, 50/1, 60/1, 70/1, 80/1, 90/1, 100/1, 1000/1 or more.

In a preferred embodiment, the composition of the invention comprises from about 3% to about 10%, more precisely from about 4.5 to about 5% of chlorogenic acid(s). In a preferred embodiment, the CGA(s) are extracted from a biological material such as Arabica, Robusta and/or Liberica green coffee beans.

In another embodiment, the composition of the invention comprises from about 10% to about 40% (w/w), more precisely between about 30% to about 35% (w/w) of a natural extracts (such as a methanol/water extract) comprising CGA(s) obtained or obtainable from a CGA(s) containing biological material (such as Arabica, Robusta and/or Liberica green coffee beans), a carrier comprising at least one carrier other than water (such as MPG) and less than 20%, %, less than 18%, less than 17%, less than 16%, less than 15%, less than 14%, less than 13%, less than 12%, less than 11%, less than 10%, less than 9%, less than 8%, less than 7%, less than 6%, less than 5%, less than 4%, less than 3%, less than 2%, less than 1% or less than 0.5% (v/v) of water. In a preferred embodiment the composition of the invention comprises from about 3% to about 10%, more precisely from about 4.5% to about 5% w/w of chlorogenic acid(s)

In another embodiment, the composition of the invention comprises from about 10% to about 40% (w/w), more precisely between about 30% to about 35% (w/w) of a Natural extract (such as a methanol/water extract) comprising CGA(s) obtained or obtainable from a CGA(s) containing biological material (such as Arabica, Robusta and/or Liberica green coffee beans), a carrier comprising water and less than 20%, less than 18%, less than 17%, less than 16%, less than 15%, less than 14%, less than 13%, less than 12%, less than 11%, less than 10%, less than 9%, less than 8%, less than 7%, less than 6%, less than 5%, less than 4%, less than 3%, less than 2%, less than 1% or 0.5% (v/v) of at least one carrier other than water (such as MPG). In a preferred embodiment the composition of the invention comprises from about 3% to about 10%, more precisely from about 4.5% to about 5% w/w of chlorogenic acid(s).

In another embodiment, the composition of the invention comprises from about 10% to 40% (w/w) more precisely between about 30% to about 35% (w/w) of a Natural extract (such as a methanol/water extract) comprising CGA(s) obtained or obtainable from a CGA(s) containing biological material (such as Arabica, Robusta and/or Liberica green coffee beans), and a carrier comprising at least one carrier other than water (such as MPG). Here the carrier is essentially free of water. In a preferred embodiment the composition of the invention comprises from about 3% to about 10%, more precisely from about 4.5% to about 5% w/w of chlorogenic acid(s).

In another embodiment, the composition of the invention comprises from about 10% to 40% (w/w) more precisely between about 30% to about 35% (w/w) of a Natural extract (such as a methanol/water extract) comprising CGA(s) obtained or obtainable from a CGA(s) containing biological material (such as Arabica, Robusta and/or Liberica green coffee beans), and water. Here the carrier is only water (i.e is essentially free of other carriers). In a preferred embodiment the composition of the invention comprises from about 3% to about 10%, more precisely from about 4.5% to about 5% of chlorogenic acid(s).

The water used in the formulation of the composition is preferably food-safe such as filtrated water.

In a preferred embodiment, the composition of the invention is presented as a concentrate. Such concentrate may be used in any of the methods or used mentioned below. In one embodiment, the composition of the invention does not form a precipitate after and/or during storage and/or light exposure.

In one embodiment, the composition of the invention does not form a precipitate after and/or during storage and/or light exposure. The composition of the invention does not form a precipitate after the formulation (mixture of the different components of the composition of the invention, for example natural extract and carrier) in 1 day, 2 days, 3, days, 4 days, 5 days, 6 days, one week, 2 weeks, 3 weeks, 4 weeks, 2 moths, 5 months, 6 months, 1 year of storage.

The composition of the invention may comprises other elements like colors, flavours etc.

The term “about” as used herein, e.g. when referring to a measurable value (such as an amount or weight of a particular component in the reaction mixture), refers to variations of ±20%, ±10%, ±5%, ±1%, ±0.5%, or, particularly, ±0.1% of the specified amount.

### Food or Beverage Product

The composition of the invention has no precipitations that appears during time. This is advantageous because it allows the extract to be used in various applications without further purification and/or refinement. Uses of CGA(s) are far-reaching and include the food and beverages, pharmaceutical, nutritional and cosmetic sectors. One particular advantage of the composition of the present invention is that it is food-grade.

The present invention also provides the use of the composition of the invention in a nutraceutical formulation, a dietary, food or drink product for humans or animals (pets foods), a nutritional supplement, a sports supplement, a fragrance or flavouring, a pharmaceutical or veterinary formulation, an oenological or cosmetic formulation.

The present invention also provides a nutraceutical formulation, a dietary, food or drink product for humans or animals, a nutritional supplement, a sports supplement, a fragrance or flavouring, a pharmaceutical or veterinary formulation, an oenological or cosmetic formulation comprising the composition of the invention.

In another aspect the invention provides the use of a composition of the invention to prevent flavours and/or colours oxidation in a beverage or food product.

In another aspect the invention provides a method for preventing flavours and/or colours oxidation in a beverage or food product for human or animals comprising the addition of a composition of the invention to said beverage or food product.

The composition of the invention may be subjected to further processing before it is added to a food or beverage product. For example it may be sterilized, it may be diluted, etc.

When used as an ingredient of nutraceutical formulation, a dietary, food or drink product for humans or animals (such as functional food formulations, i.e. food, drink, feed or pet food or a food, drink, feed or pet food supplements), a nutritional supplement, a fragrance or flavouring, a pharmaceutical or veterinary formulation, an oenological or cosmetic formulation, the composition of the invention may be added at any appropriate step in the production process of said food or beverage product, etc to achieve the desired effect of the CGA(s). The composition of the invention may also be added in any amount suitable to bring about the desired effect of the CGA(s). The composition of the invention may be presented as a concentrate. Thus it may be added to the food or beverage etc. at small amounts or it can prediluted previously to the addition to the desired food, beverage etc to reach the desirable amount of CGA(s) and obtain the desired effect (such as anti-oxidant, etc).

The food or beverage product may be any food or beverage product known in the art. For example, the food or beverage product may be a coffee product, a tea beverage, a soft drink, water (e.g. bottled water), a dietary supplement, a nutritional supplement, a dairy product (e.g. yoghurt, milk powder, milk-based dessert), a cereal product, a fruit or vegetable juice product, or a confectionary product. Preferably the food or beverage product is a beverage product such as coffee, tea, a soft drink, a fruit or vegetable juice product or water (e.g. bottled water).

The compositions, or food or beverage products of the present invention may contain (e.g. may have been supplemented with) additional vitamins, minerals and micronutrients, including trace elements, in accordance with the recommendations (e.g. recommended daily intake guidelines) of government bodies.

Food encompasses the following general food categories, as defined by the Food and Drug Administration (FDA): baked goods and baking mixes, including all ready-to-eat and ready-to-bake products, flours, and mixes requiring preparation before serving; beverages, alcoholic, including malt beverages, wines, distilled liquors, and cocktail mix; beverages and beverage bases, non-alcoholic, including only special or spiced teas, soft drinks, coffee substitutes, and fruit and vegetable flavored gelatin drinks; breakfast cereals, including ready-to-eat and instant and regular hot cereals; cheeses, including curd and whey cheeses, cream, natural, grating, processed, spread, dip, and miscellaneous cheeses; chewing gum, including all forms; coffee and tea, including regular, decaffeinated, and instant types; condiments and relishes, including plain seasoning sauces and spreads, olives, pickles, and relishes, but not spices or herbs; confections and frostings, including candy and flavored frosting, marshmallows, baking chocolate, and brown, lump, rock, maple, powdered, and raw sugars; dairy product analogs, including nondairy milk, frozen or liquid creamers, coffee whiteners, toppings, and other nondairy products; egg products, including liquid, frozen, or dried eggs, and egg dishes made therefrom, i.e., egg roll, egg foo young, egg salad, and frozen multicourse egg meals, but not fresh eggs; fats and oils, including margarine, dressings for salads, butter, salad oils, shortenings and cooking oils; fish products, including all prepared main dishes, salads, appetizers, is frozen multicourse meals, and spreads containing fish, shellfish, and other aquatic animals, but not fresh fish; fresh eggs, including cooked eggs and egg dishes made only from fresh shell eggs; fresh fish, including only fresh and frozen fish, shellfish, and other aquatic animals; fresh fruits and fruit juices, including only raw fruits, citrus, melons, and berries, and home-prepared “ades” and punches made therefrom; fresh meats, including only fresh or home-frozen beef or veal, pork, lamb or mutton and home-prepared fresh meat-containing dishes, salads, appetizers, or sandwich spreads made therefrom; fresh poultry, including only fresh or home-frozen poultry and game birds and home-prepared fresh poultry-containing dishes, salads, appetizers, or sandwich spreads made therefrom; fresh vegetables, tomatoes, and potatoes, including only fresh and home-prepared vegetables; frozen dairy desserts and mixes, including ice cream, ice milks, sherbets, and other frozen dairy desserts and specialties; fruit and water ices, including all frozen fruit and water ices; gelatins, puddings, and fillings, including flavored gelatin desserts, puddings, custards, parfaits, pie fillings, and gelatin base salads; grain products and pastas, including macaroni and noodle products, rice dishes, and frozen multicourse meals, without meat or vegetables; gravies and sauces, including all meat sauces and gravies, and tomato, milk, buttery, and specialty sauces; hard candy and cough drops, including all hard type candies; herbs, seeds, spices, seasonings, blends, extracts, and flavorings, including all natural and artificial spices, blends, and flavors; jams and jellies, home-prepared, including only home-prepared jams, jellies, fruit butters, preserves, and sweet spreads; jams and jellies, commercial, including only commercially processed jams, jellies, fruit butters, preserves, and sweet spreads; meat products, including all meats and meat containing dishes, salads, appetizers, frozen multicourse meat meals, and sandwich ingredients prepared by commercial processing or using commercially processed meats with home preparation; milk, whole and skim, including only whole, lowfat, and skim fluid milks; milk products, including flavored milks and milk drinks, dry milks, toppings, snack dips, spreads, weight control milk beverages, and other milk origin products; nuts and nut products, including whole or shelled tree nuts, peanuts, coconut, and nut and peanut spreads; plant protein products, including the National Academy of Sciences/National Research Council “reconstituted vegetable protein” category, and meat, poultry, and fish substitutes, analogs, and extender products made from plant proteins; poultry products, including all poultry and poultry-containing dishes, salads, appetizers, frozen multicourse poultry meals, and sandwich ingredients prepared by commercial processing or using commercially processed is poultry with home preparation; processed fruits and fruit juices, including all commercially processed fruits, citrus, berries, and mixtures; salads, juices and juice punches, concentrates, dilution, “ades”, and drink substitutes made therefrom; processed vegetables and vegetable juices, including all commercially processed vegetables, vegetable dishes, frozen multicourse vegetable meals, and vegetable juices and blends; snack foods, including chips, pretzels, and other novelty snacks; soft candy, including candy bars, chocolates, fudge, mints, and other chewy or nougat candies; soups, home-prepared, including meat, fish, poultry, vegetable, and combination home-prepared soups; soups and soup mixes, including commercially prepared meat, fish, poultry, vegetable, and combination soups and soup mixes; sugar, white, granulated, including only white granulated sugar; sugar substitutes, including granulated, liquid, and tablet sugar substitutes; and sweet sauces, toppings, and syrups, including chocolate, berry, fruit, corn syrup, and maple sweet sauces and toppings.

### Pharmaceutical and Nutraceutical Composition

In a further embodiment, it is provided the use of the composition of the invention (comprising CGA(s)) in a pharmaceutical or nutraceutical composition.

In one embodiment, the invention comprises combining the composition of the invention of the invention with at least one of a pharmaceutically or nutraceutical acceptable carrier, diluent or excipient to form a pharmaceutical composition or a nutraceutical composition.

The composition of the invention may be formulated in a pharmaceutically or nutraceutical acceptable medium.

Examples of such suitable excipients for compositions described herein may be found in the “Handbook of Pharmaceutical Excipients, 2nd Edition, (1994), Edited by A Wade and PJ Weller. Acceptable carriers or diluents for therapeutic use are well known in the pharmaceutical art, and are described, for example, in Remington's Pharmaceutical Sciences, Mack Publishing Co. (A. R. Gennaro edit. 1985).

Examples of suitable carriers include lactose, starch, glucose, methyl cellulose, magnesium stearate, mannitol, sorbitol and the like. Examples of suitable diluents include ethanol, glycerol and water.

The choice of pharmaceutical (or nutraceutical) carrier, excipient or diluent can be selected with regard to the intended route of administration and standard pharmaceutical practice. The pharmaceutical compositions may comprise as, or in addition to, the carrier, excipient and/or diluent any suitable binder(s), lubricant(s), suspending agent(s), coating agent(s) and/or solubilising agent(s). Examples of suitable binders include starch, gelatin, natural sugars such as glucose, anhydrous lactose, free-flow lactose, beta-lactose, corn sweeteners, natural and synthetic gums, such as acacia, tragacanth or sodium alginate, carboxymethyl cellulose and polyethylene glycol. Examples of suitable lubricants include sodium oleate, sodium stearate, magnesium stearate, sodium benzoate, sodium acetate, sodium chloride and the like.

Preservatives, stabilisers, dyes and even flavouring agents may be provided in the composition. Examples of preservatives include sodium benzoate, sorbic acid and esters of p-hydroxybenzoic acid. Antioxidants and suspending agents may be also used. Nutritionally acceptable carriers, diluents and excipients include those suitable for human or animal consumption and that are used as standard in the food industry. Typical nutritionally acceptable carriers, diluents and excipients will be familiar to the skilled person in the art.

For the avoidance of doubt, in this specification when we use the term “comprising” or “comprises” we mean that the extract or composition being described must contain the listed ingredient(s) but may optionally contain additional ingredients. When we use the term “consisting essentially of” or “consists essentially of” we mean that the extract or composition being described must contain the listed ingredient(s) and may also contain small (for example up to 5% by weight, or up to 1% or 0.1% by weight) of other ingredients provided that any additional ingredients do not affect the essential properties of the extract or composition. When we use the term “consisting of” or “consists of” we mean that the extract or composition being described must contain the listed ingredient(s) only.

It is also intended that the terms “comprise” or “comprises” or “comprising” may be replaced with “consist” or “consisting” or “consisting essentially of” throughout the application as required

### EXAMPLES

### Extract Preparation

Green coffee beans of Coffea arabica or of Coffea robusta were ground and extracted using alcoholic extraction. Any other plant or organism comprising chlorogenic acid, or any other process providing or yielding chlorogenic acid, may be used.

Here, the extraction solvent was composed from 75% methanol and 25% water.

Thus obtained extract was filtered and concentrated. Concentrated extract was supplemented with organic or weak or strong acid, in here with citric acid. The obtained extract was further filtered and concentrated. After concentration, the solvent levels are decreased and in the final concentrate, the dry matter corresponds to approximately between 20-40% w/w, more precisely, 33% w/w. The CGA concentration in the final extract is from about 13% to 16% w/w.

The concentrate may or not be dried prior to formulation that corresponds to the addition of water and/or MPG.

Sterilisation methods could be applied at any step of extraction.

### Liquid Formula

Finally, the extract was formulated with monopropylene glycol (MPG) that was added at 20% to 25% and thus obtained formulated extract comprising 4.5% w/w to 5% w/w chlorogenic acid.

### Results

To the dry extract excluded from water (33.31% of solids), the following proportions of water and MPG were added in order to attain the final formula (see table 1). The final formulas represented on table 1 have a concentration of chlorogenic acid from 4.5% to 5% (w/w).

Each formula was kept for seven days at room temperature, unprotected from sunlight.

The results observed after seven days remained and extended to at least four months.

The following formulas were monitored:

TABLE 1

| Extract (solid | | | |
|---|---|---|---|
| components) | Water | MPG | Sedimentation |
| 33.31% | 0% | 66.69% | None* |
| 33.31% | 23.19% | 43.50% | Yes +++ |
| 33.31% | 27.54% | 39.15% | Yes +++ |
| 33.31% | 31.89% | 34.80% | Yes +++ |
| 33.31% | 36.24% | 30.45% | Yes +++ |
| 33.31% | 40.59% | 26.10% | Yes +++ |
| 33.31% | 44.94% | 21.75% | Yes +++ |
| 33.31% | 49.29% | 17.40% | Yes +++ |
| 33.31% | 53.64% | 13.05% | Traces* |
| 33.31% | 57.99% | 8.70% | Traces* |
| 33.31% | 62.34% | 14.35% | None* |
| 33.31% | 66.69% | 0.00% | None* |

*surprising effect

Clearly, the above data show that mixtures made from water and MPG, when added to green bean coffee extract, induce the unwanted sediment formation. Surprisingly, such sediments are not formed when only water with very little MPG, more precisely, when 0 to 12% of MPG and 52 to 66.7% of water, or when only MPG, without water are added, more precisely when 66.7% MPG and 0% of water are added to 33.31% of extract. It is surprising that combinations with extreme proportions in water or MPG alleviate from sedimentation problem.

1. A composition comprising:
(i) a natural extract comprising at least one chlorogenic acid; and
(ii) a carrier comprising at least one of a carrier other than water and water,
wherein the natural extract is extracted using a solvent comprising water, alcohol, acetone, ethyl acetate, hexane, dichloromethane, or mixtures thereof.

2. The composition according to claim 1, wherein the natural extract is extracted from a biological material that contains chlorogenic acids.

3. The composition according to claim 2, wherein the biological material comprises a plant biological material.

4. (canceled)

5. The composition according to claim 1, wherein the solvent comprises a methanol/water solvent.

6. The composition according to claim 1, wherein the at least one chlorogenic acid content is from about 2% to about 40% w/w.

7. The composition according to claim 6, wherein the at least one chlorogenic acid is a natural methanol/water extract comprising chlorogenic acid obtained or obtainable from at least one of Arabica, Robusta and Liberica green coffee beans and wherein the concentration of chlorogenic acid in the natural extract is from about 8% to about 20% w/w.

8. The composition according to claim 1, wherein the at least one chlorogenic acid is selected from neo-chlorogenic acid, crypto-chlorogenic acid, n-chlorogenic acid, iso-chlorogenic acid A, iso-chlorogenic acid B, iso-chlorogenic acid C, and mixtures thereof.

9. The composition according to claim 1, wherein the carrier comprises at least one carrier other than water and water, and wherein the ratio between the at least one carrier other than water and water is more than about 1.9/1.

10. The composition according to claim 1, wherein the carrier comprises at least one carrier other than water and water, and wherein the ratio between water and the at least one carrier other than water is more than about 4/1.

11. The composition according to claim 1, wherein the carrier is free of water.

12. The composition according to claim 1, wherein the carrier other than water is selected from ethanol, methanol, dipropylene glycol, n-propylene glycol, monopropylene glycol, ethylene glycol, glycerine, triacetin, and mixtures thereof.

13. The composition according to claim 12, wherein the carrier other than water is monopropylene glycol.

14. The composition according to claim 1, wherein the carrier is only water.

15. The composition according to claim 1, wherein the composition does not have a precipitate under at least one of the following conditions after storage, during storage, and light exposure.

16. A method of using the composition according to claim 1 in a nutraceutical formulation, a dietary product for humans or animals, a food product for humans or animals, a drink product for humans or animals, a nutritional supplement, a sports supplement, a fragrance, a flavouring, a pharmaceutical formulation, a veterinary formulation, an oenological formulation, or a cosmetic formulation.

17. A nutraceutical formulation, a dietary product for humans or animals, a food product for humans or animals, a drink product for humans or animals, a nutritional supplement, a sports supplement, a fragrance, a flavouring, a pharmaceutical formulation, a veterinary formulation, an oenological formulation, or a cosmetic formulation comprising the composition according to claim 1.

18. A method of using the composition according to claim 1 to prevent oxidation of at least one of flavours and colours in a beverage or food product.

19. The composition according to claim 3, wherein the plant biological material is selected from the genus Coffea, leaves of flex paraguariensis, pome fruits, stone fruits, berry fruits, citrus fruits, brassica vegetables, Solanaceae, Asteraceae, cereal grains, or combinations thereof.

20. The composition according to claim 19, wherein the plant biological material is selected from Coffea arabica green beans, Coffea canephora green beans, Coffea liberica green beans, or combinations thereof.

21. The composition according to claim 1, wherein the solvent may be partially or completely removed from the natural extract.

22. The composition according to claim 21, wherein the solvent is completely removed to form a solid natural extract.

23. The composition according to claim 22, wherein the solid natural extract comprises chlorogenic acids from about 3% to about 50% w/w.

24. The composition according to claim 1, wherein the natural extract comprising at least one chlorogenic acid comprises at least one of from about 5% to about 99% w/w of solids and about 3% to about 50/6 total chlorogenic acid content.

25. The composition according to claim 2, wherein the natural extract comprising at least one chlorogenic acid comprises at least one of from about 5% to about 99% w/w of solids and about 3% to about 50% total chlorogenic acid content.
